(19) United States
(12) Patent Application Publication
(10) Pub. No.: US 2013/0290201 A1
(43) Pub. Date: Oct. 31, 2013

(54) SYSTEMS AND METHODS FOR ASSESSING THE LEGITIMACY OF A TRANSPORTATION PROVIDER

(71) Applicant: Rosendo Jose Rodriguez Carrillo, Salem, OR (US)

(72) Inventor: Rosendo Jose Rodriguez Carrillo, Salem, OR (US)

(21) Appl. No.: 13/878,998

(22) PCT Filed: Oct. 12, 2011
(86) PCT No.: PCT/US11/56041

§ 371 Date: Jul. 8, 2013

Related U.S. Application Data
(60) Provisional application No. 61/392,422, filed on Oct. 12, 2010.

(51) Int. Cl. G06Q 30/00

(52) U.S. Cl. CPC G06Q 30/0185
USPC 705/318

(57) ABSTRACT

Systems and methods are provided to enable users to assess the legitimacy of an alleged transportation provider. In an embodiment, a method for assessing the legitimacy of a transportation provider comprises retrieving from a user information relating to an alleged transportation provider. The system then accesses information relating to the alleged transportation provider. The system then assesses whether the alleged transportation provider is a legitimate transportation provider. Next, the system flags the alleged trasportation provider as legitimate or illegitimate. The system then transmits to the user information relating to the legitimacy of the alleged transportation provider. The system can provide crime insurance and other services to users based on the assessment of the legitimacy of the transport of choice and user stated preferences.

### CROSS-REFERENCE

This application claims the benefit of U.S. Provisional Application No. 61/392,422, filed Oct. 12, 2010, which application is incorporated herein by reference in its entirety.

### BACKGROUND OF THE INVENTION

Users can travel with the aid of transportation services. Transportation services can be offered by transportation providers, such as, e.g., for-hire transportation providers, including taxicab (“cab”) drivers, bus drivers, limousine drivers and operators of town cars. To hire a for-hire transportation provider, a user typically stands near a street or a call-location (e.g., taxicab stand) and uses one or more of voice calls, hand gestures and body gestures to call a for-hire transportation provider. A transportation provider that is available for hire then approaches the user and permits the user to enter the vehicle being operated by the transportation provider.

### SUMMARY OF THE INVENTION

In some situations, transportation user safety when enlisting the services of a for-hire transportation (transport) provider is an issue. A users may be at risk in a situation in which a criminal assumes the role of a taxicab operator to lure an unwary user with the intent of committing a crime against the user, such as stealing the user's property and even inflicting bodily harm or injury against the user. Transportation providers also have a safety concern regarding the legitimacy or intentions of transport passengers. In some cases, a transportation provider may be at risk in a situation in which a criminal assumes the role of a passenger to commit a crime against the transport operator, such as stealing the transport operator's property and even inflicting bodily harm or injury against the transport operator. Recognized herein is the need for systems and methods to help users screen for fraudulent transport providers and other strangers occupying transport vehicles with users, as well to help transport operators screen for fraudulent passengers.

In an aspect of the invention, a system for assessing the legitimacy of a transportation provider is provided. The system comprises a first module configured to receive information relating to an alleged transportation from a user and store the information in a memory location. The system further comprises a second module operatively coupled to the first module, the second module for using the information received from the user to assess, using a processor, the legitimacy of the alleged transportation provider, and a third module operatively coupled to the second module, the third module for transmitting to the user an indication as to the legitimacy of the alleged transportation provider. In one embodiment, the system further comprises a module configured to offer crime insurance and other services to users.

In another aspect, a system is provided for deterring crimes and abuses by transportation providers against transportation users. In an embodiment, the system comprises a first module configured to assess the legitimacy of a transportation provider; and a second module for notifying (or reporting), storing and providing strong evidence to users, law enforcement agencies and designated third parties against transport operators in the event of a crime. In another embodiment, the system can include a second module that is configured to report an illegitimate transporter provider to other users and/or the authorities.

In yet another aspect, a method for assessing the legitimacy of a transportation provider is provided. The method can be implemented with the aid of a computer. The method comprises retrieving from a user information relating to an alleged transportation provider; accessing, from a memory location, information of or relating to the alleged transportation provider; assessing, with the aid of a processor operatively coupled to the memory location, whether the alleged transportation provider is a legitimate transportation provider; flagging the alleged transportation provider as legitimate or illegitimate based on the assessment; and transmitting to the user information relating to the legitimacy of the alleged transportation provider. In one embodiment, information relating to the legitimacy of the alleged transportation provider is transmitted to other system users and authorities. In another embodiment, the system can offer crime insurance and other services to users based on the assessment of transport legitimacy, user information and other criteria. In an embodiment, assessing whether the alleged transportation provider is a legitimate transportation provider comprises determining whether the alleged transportation provider has deviated from a predetermined route. In another embodiment, assessing whether the alleged transportation provider is a legitimate transportation provider comprises determining whether the user has inputted a user-specific code into an electronic device of the user. In another embodiment, the method further comprises notifying a law enforcement official or a user-designated third party after flagging the alleged transportation provider as legitimate or illegitimate. In another embodiment, the method further comprises updating the information relating to the alleged transportation provider. In another embodiment, the method further comprises providing crime insurance and other services to the user based on the assessment of the legitimacy of the transportation provider and/or preferences provided by the user. In another embodiment, assessing whether the alleged transportation provider is a legitimate transportation provider comprises determining one or more of whether the alleged transportation provider has a criminal record, whether the alleged transportation provider is driving a stolen, unregistered or disguised vehicle, and whether the alleged transportation provider is a criminal or has exhibited criminal behavior.

In some embodiments, a legitimate transportation provider is authorized or otherwise permitted to use a transport vehicle. In some embodiments, an illegitimate transportation provider is not authorized or otherwise permitted to use a transport vehicle.

In still another aspect of the invention, a computer-implemented method for assessing the legitimacy of a transportation provider is provided. The computer-implemented method comprises retrieving from a user information relating to an alleged transportation provider; accessing information relating to the alleged transportation provider; assessing whether the alleged transportation provider is a legitimate transportation provider; flagging the alleged transportation provider as legitimate or illegitimate; and transmitting to the user information relating to the legitimacy of the alleged transportation provider. In one embodiment, information relating to the legitimacy of the alleged transportation provider is transmitted to other system users and authorities. In another embodiment, the system can offer crime insurance and other services (such as, e.g., transport reservations (bookings), electronic payments and receipts, expense reporting, advertisements and general information) to users based on the assessment of transport legitimacy, user information and other criteria.

In still another aspect of the invention, a computer-implemented method for deterring crimes and abuses by transportation providers against transportation users comprises notifying, storing and providing strong evidence to users, law enforcement agencies and designated third parties against transport operators in the event of a crime. In an embodiment, transport operators can include transport license owners. In another embodiment, transport operator can include drivers. In another embodiment, transport operators can include vehicles. In yet another embodiment, transport operators can include license owners and/or drivers and/or vehicles operated by the drivers.

In another aspect, a system for notifying a user as to the legitimacy of a transportation provider comprises a server having a memory location including computer-executable code for implementing any of the methods above, alone or in combination, and a graphical user interface (GUI) for providing the user a notification as to the legitimacy or illegitimacy of the transportation provider, wherein the notification is provided by the server. In an embodiment, the GUI is on an electronic device of the user, the electronic device located remotely from the server. In another embodiment, the notification is a visual notification.

In another aspect, a computer-implemented method for assessing the legitimacy of an alleged stranger is provided. The method comprises a system (or server) retrieving from a user information relating to an alleged stranger. The user is occupying a transport vehicle with the alleged stranger or is deciding whether to occupy the transport vehicle with the alleged stranger. Next, from a memory location, the system accesses information relating to the alleged stranger. With the aid of a processor operatively coupled to the memory location, the system determines a likelihood that the alleged stranger will commit a crime against the user. Based on the processor-determined likelihood, the system alerts one or more of the user, a law enforcement official and user-selected third parties. In an embodiment, the system provides crime insurance and other services to the user based on the processor-determined likelihood and/or preferences provided by the user. In another embodiment, determining the likelihood that the alleged stranger will commit a crime against the user comprises determining one or more of whether the alleged stranger has a criminal record, whether the alleged stranger is driving a stolen, unregistered or disguised vehicle, and whether the alleged stranger is a criminal or has exhibited criminal behavior. In another embodiment, the alleged stranger is an alleged transport operator. In another embodiment, determining the likelihood that the alleged stranger will commit a crime against the user comprises determining, with the aid of the processor, the likelihood that the alleged stranger will commit a crime against the user within a time period in which the user and the alleged stranger concurrently occupy the transport vehicle.

In some embodiments, an alleged stranger is a criminal or an individual exhibiting or having exhibited criminal behavior. An alleged stranger may be a passenger of a vehicle concurrently occupied by the user.

In some embodiments, an alleged transportation (or transport) provider is a criminal or an individual exhibiting or having exhibited criminal behavior. An alleged transport provider may have authorized use of the vehicle, but otherwise exhibiting or having exhibited criminal behavior. Alternatively, an alleged transport provider may not have authorized use of a vehicle.

Methods above, alone or in combination, can be implemented with one or more computer systems (e.g., a standalone system or a plurality of systems operatively coupled to one another) having processors, such as central processing units (CPU's), memory locations, and data storage units, such as hard drives.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 schematically illustrates a system for assessing the legitimacy of an alleged transportation provider, in accordance with an embodiment of the invention; and

FIG. 2 schematically illustrates a method for assessing the legitimacy of an alleged transportation provider and providing a user, such as a potential passenger, information as to the legitimacy of the alleged transportation provider, in accordance with an embodiment of the invention.

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will occur to those skilled in the art without departing from the invention. It should be understood that various alternatives to the embodiments of the invention described herein can be employed in practicing the invention.

In for-hire transportation services (e.g., taxis, buses, limousines, town cars), information asymmetries between transportation (also “transport” herein) users and transportation providers can allow criminals to disguise themselves as legitimate transportation providers. In some cases, fraudulent transport providers might abuse or perpetrate crimes against transport users. For example, an individual might disguise himself as a taxi driver and lure an unwary passenger into his vehicle, which might also be disguised as a taxi. The individual might subsequently commit various crimes against the passenger, such as kidnapping, robbing or assaulting the passenger. In addition, a transport provider may charge transport users higher tariffs or fares than those permitted by the authorities or take them through a longer route to exact a higher tariff or fare.

The term “crime,” as used herein, refers to misdemeanors, bodily offenses, property crimes, infractions, abuses, minor offenses, or any other acts or omissions that are deemed not legal by a city government, state government, federal government, local authority, territorial authority, or other authority or regulatory entity. In some examples, a crime includes negligent, reckless behavior, or bad faith acts or omissions. In some embodiments, a criminal is an individual that has perpetrated a crime or facilitated the perpetration of a crime. Criminals can include conspirators (or co-conspirators) of crimes.

In some embodiments, systems and methods are provided for providing transportation users (also “transport users” and “users” herein) information as to the legitimacy of alleged transportation providers (also “transport providers” and “operators” herein). Prior to accepting a transport provider's services, systems and methods provided herein can enable transport users to assess whether an alleged transport provider is a legitimate transport provider or a fraudulent transport provider, such as a criminal. This can advantageously prevent any adverse consequences of a transport user accepting the services of a fraudulent transport provider and provide incentives for irregular transport providers to regularize their situation. In embodiments, systems and methods are provided for collecting information relating to transportation providers and providing to one or more users reliable information about the legitimacy of the transportation providers.

In some embodiments, systems and methods are provided for providing transport providers (or operators) information as to the reliability of a transport user. In an embodiment, a transport operator can query the system to determine whether the potential transport user (or passenger) meets certain provider query criteria, such as whether the potential passenger has a criminal history and the potential passenger's credit history.

Systems and methods provided herein can enable a passenger (or other user) to provide information about an alleged transportation provider to a transportation provider reliability assessment system (the “system”). The system can then create a record of the alleged transportation provider or update an existing record of the transportation provider. In an embodiment, the registration with the system can act as a prevention mechanism, as the alleged transportation provider now knows that by registering his car, photo (image) or voice, the passenger (or other user) has left a trace. In an embodiment, this system of accountability can encourage the best and safest driver behavior. In an embodiment, the information provided by the passenger (such as, e.g., vehicle registration number, license plate number, a license plate image, an image of a vehicle, an image of a driver, an image of a permit, the driver's voice, the driver's fingerprint(s) or other biometric data) can be immediately registered, recognized (e.g., OCR, Face or Voice Recognition Software) and compared against government databases (e.g., DMV, Police, Judiciary) motor vehicle registration information, reported incidents, a user rating database, and information provided by other users, including other passengers. The user can instantly (or nearly instantly) receive a message (e.g., text message, enhanced message, multimedia message, email, voice message) or a voice response (e.g., live, automated) with the vehicle's registration details, the details of any previous reported incidents and a rating for the vehicle operated by the alleged transportation provider. The message may be communicated to the user with the aid of various systems and software. In an example, the user receives a message with the aid of a social network or other network communication system, such as, for example, systems selected from instant messaging systems (e.g., America Online, IM), Twitter, Facebook, or Google+, Skype, Microsoft Messenger, Black Berry Messenger, WhatsUp, iMessage, and the like. Such a response by the system can enable a passenger to make an informed decision as to whether to enter the alleged transportation provider's vehicle, stay in the vehicle, or leave. In an embodiment, this system (or method) of accountability can encourage the regularization of illegitimate transport providers to allow them to freely provide services to users of the system that would otherwise turn down their services.

In an embodiment, immediately after, or simultaneously with, a query, the system can alert the relevant authorities as to the presence of an illegitimate transport provider and possible criminal activity against users and provide their location when available.

In an embodiment, once the ride is over, the passenger (or other user) has the option to rate the journey, e.g., via mobile or online access to the system. For example, the passenger can rate the journey on a scale of 1 to 5, with 5 indicating complete satisfaction with the journey (including satisfaction with the driver's performance) and 1 indicating complete dissatisfaction with the journey. In an embodiment, users' safe arrival confirmations will be included in transport operator's profiles, individually and collectively (e.g., for base and/or call-in stations.)

In an embodiment, prior to entering the vehicle of an alleged transportation provider or soon thereafter, a passenger informs the system that she or he is about to enter a particular vehicle. Upon arrival at the passenger's destination, the passenger would call or send the system a message (e.g., text message, enhanced message, multimedia message, email message, voice message) to confirm safe arrival. The message may be communicated to the system with the aid various communications systems, including a social network or other network communication system, such as, for example, systems selected from instant messaging systems (e.g., America Online, IM), Twitter, Facebook, or Google+, Skype, Microsoft Messenger, Black Berry Messenger, WhatsUp, iMessage, and the like. If the passenger does not inform the system within a predetermined time period, the system can inform the passenger's designated contact and/or law enforcement officials. In an embodiment, the system can record users queries and provide the safe arrival confirmation by default when a user queries a certain type of transportation (e.g., illegitimate transport provider, operator with a criminal background, etc.) In an embodiment, safe arrival confirmation can be carried out by third parties contacting users (e.g., law enforcement officials, passenger's designated contacts) or by users contacting third parties directly (e.g., law enforcement officials, passenger's designated contacts.)

### Systems for Providing Transportation Provider Reliability Information

In an aspect of the invention, transportation provider reliability assessment systems are provided for collecting from one or more users information relating to a transportation provider, assessing the legitimacy of the transportation provider, and providing to the user information as to the legitimacy of the transportation provider. Systems provided herein can reduce, if not eliminate, any asymmetries between fraudulent transport providers (including criminals) and unsuspecting transportation users.

Reference will now be made to the figures, wherein like numerals refer to like parts throughout. It will be appreciated that the figures are not necessarily drawn to scale.

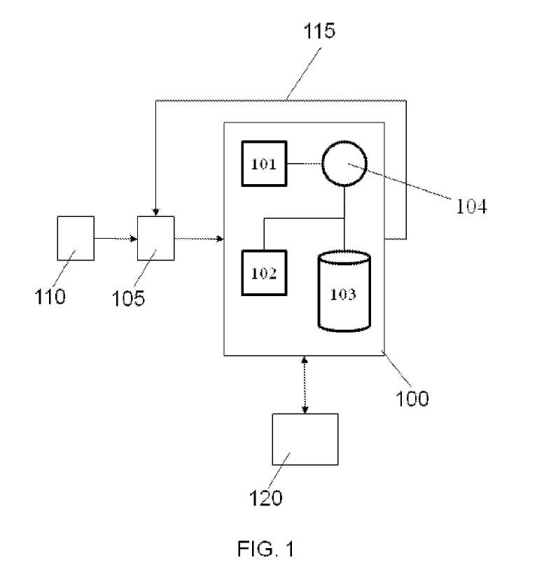

With reference to FIG. 1, a transportation provider reliability assessment system (also “system” herein) 100 is shown, in accordance with an embodiment of the invention. The system includes a memory location (e.g., flash memory) 101, communications interface (e.g., wireless interface, wired interface) 102, a data storage unit (e.g., one or more hard disks) 103 and a processor 104 operatively coupled to the memory location 101, the communications interface 102 and the data storage unit 103. The communications interface 102 is for bringing the system 100 in communication with one or more remote devices, such as by way of an intranet or the Internet. The communications interface 102 may bring the system in communication with other system by way of wired or wireless communication.

With continued reference to FIG. 1, a user 105 collects information relating to a transportation provider 110. The user 105 transmits the information collected from the transportation provider 110 to the transportation provider reliability assessment system 100 for processing. The system 100 can compare the information provided by the user 105 to information relating to the transportation provider 110 in the system's database(s) or other module (or subsystem) included in the system 100. The system 100 can then provide the user 105 legitimacy and reliability information 115. In an embodiment, the system 100 informs the user 105 via mobile messaging technologies (e.g., SMS, EMS, MMS). In another embodiment, the system 100 informs the user 105 via electronic mail (“email”). In another embodiment, the system 100 informs the user 105 via telephone. In yet another embodiment, the system 100 informs the user 105 via video. The information 115 can include criminal information relevant to the transport provider (license owner and/or driver and/or vehicle) 110. For example, the information 115 can include recent criminal activity of the transport provider 110. In an embodiment, the information 115 can include an indication as to the reliability and legitimacy of the transportation provider 110, such as, for example, a visual or verbal response relating to the reliability of the transport provider 110. In an embodiment, the information 115 can include the driving record of the operator 110.

In one embodiment, the system 100 can include one or more computer systems for retrieving information from the user 105, processing the information, and transmitting information back to the user 105 and other individuals or entities, such as other users and law enforcement officials. The system 100 can include network interfaces configured to interact with other computer systems, via one or both of the internet or an intranet. The system 100 can include one or more databases for storing and retrieving information.

In an embodiment, the system 100 is configured to interact with peripheral systems 120 to retrieve information relating to the transport provider 110. The peripheral systems can include crime (or criminal) databases, such as citizen databases, police databases and state and government databases, including, without limitation, the Department of Motor Vehicles (“DMV”) and the Department of Homeland Security or its counterparts in other countries. In an embodiment, the system 100 can update various peripheral systems 120 with information retrieved from the user 105 or information accessible to the system 100.

In one embodiment, the transportation provider 110 includes the transportation license owner. In another embodiment, the transportation provider 110 includes a driver of a transportation vehicle (e.g., bus, taxi, limousine, town car). In another embodiment, the transportation provider 110 includes a transportation vehicle. In yet another embodiment, the transportation provider 110 includes a transportation vehicle and driver operating the vehicle. In another embodiment, the transportation provider 110 includes the transportation license owner, a driver of a transportation vehicle and a transportation vehicle.

In one embodiment, the user 105 collects driver information (e.g., license number, image, biometric data) relating to the transportation provider 110 and transmits the information to the system 100. In another embodiment, the user 105 collets vehicle information (e.g., an image of the vehicle, an image of the vehicle's license plate, an image of the transport license or permit) relating to the transportation provider and transmits the information to the system 100. In yet another embodiment, the user 105 collects vehicle information and vehicle driver information (e.g., a bar code image) relating to the transportation provider and transmits the information to the system 100.

In one embodiment, the system 100 will gather information relating to the vehicle of the transportation provider 110. In another embodiment, the system 100 will gather information relating to the driver of the transportation provider 110. In yet another embodiment, the system 100 will gather information relating to the transportation license or authorization of the transportation provider 110.

In one embodiment, the system 100 can calculate transportation fare rates in accordance with government established guidelines for the type of service authorized to the transportation provider 110, via GPS tracking and mapping of the user's 105 portable electronic device, the device's clock, trip directions provided by users (e.g., a to-and-from address) or initial and final user locations. In another embodiment, the system 100 can provide alternative map routes, directions and fare rates to users' destinations and compare them to the actual route taken by the transportation provider 110, which can prevent fraud. The system can track transport operators who deviate from predetermined or system-computed routes (e.g., routes determined by the system to be efficient routes) and as a result take more time than necessary to reach a destination. The system can also compare actual cost to its estimated cost (e.g., average cost) per route, and include over-billing or inefficiency as a metric for transport ratings, or as evidence to law enforcement and third parties of fraudulent practices.

In an embodiment, the system shows users alternate routes to and from their destinations, and indicate an estimated time of arrival (ETA) for each user. This may help reduce crime by alerting users as to their whereabouts vis-a-vis their destination and selected routes. In an example, the system permits a user to request a particular predetermined or user-defined route instead of being lead by the transport operator through the transport operator's route of choice. In some situations, criminal transport providers (illegitimate or legitimate) may have established routes to meet any accomplices along the way, who board the transport vehicle and commit crimes. This may give the user or third parties the impression that the encounter occurred by chance, leaving the transport operator free of suspicion to continue operating. In an embodiment, the system would keep track of crimes committed in a given transport unit or by a transport operator (same owner, different vehicles) and report such crimes (e.g., by way of an alert or notification) to users in their queries, as well as time and place of such crimes. If a pattern emerges for a single unit or a transport operator, in some cases the system alerts law enforcement authorities as well.

In an embodiment, the information relating to the transportation provider 110 collected by the user 105 can include a visual or verbal description (e.g., picture) of the transportation provider 110, and a visual or verbal description (e.g., picture) of the transportation provider's 110 vehicle or vehicle license plate. For example, the user 105 can take a picture of the transport provider's 110 license plate and transmit the picture to the system 100 for processing. As another example, the user 105 can take a voice sample (or exemplar) of the transport provider 110 and transmit the voice sample to the system 100 for processing.

In embodiments, the user 105 can collect information relating to the transport provider 110 using an electronic device, such as a portable electronic device. The electronic device can include a portable telephone (e.g., Smart Phone), computer, tablet, camera, or mobile device configured to communicate with the system 100. In an example, the portable electronic device is a tablet or slate PC (e.g., iPad, Galaxy Tab), a Smart Phone (e.g., iPhone, Android enabled phone, Black Berry, HTC phone), a laptop, or the like.

In an embodiment of the invention, information 115 relating to the legitimacy of the transportation provider 110 can be relayed (or communicated) to the user 105 with the aid of one or more communication systems, such as electronic mail (“email”), the Internet, short messaging service (SMS), enhanced messaging service (EMS), multimedia messaging service (MMS), Optical Character Recognition (OCR), a facial recognition system, an interactive voice response (IVR) system and a global positioning system (GPS) locator. The information 115 may be communicated to the user 105 with the aid of various communications systems, including a social network or other network communication system, such as, for example, systems selected from instant messaging systems (e.g., America Online, IM), Twitter, Facebook, or Google+, Skype, Microsoft Messenger, Black Berry Messenger, WhatsUp, iMessage, and the like. Such information can provide the user 105 with reliable information about the legitimacy of its choice of public or private transportation (e.g., taxi), including the transport provider 110.

In an embodiment, the system 100 can track and map the location of the user 105 during transit on public or private transportation. In addition, the system 100 can create a record of the user's 105 trip information for storage and subsequent transmission or retrieval by the user 105, third parties, including designated third parties, or law enforcement authorities. Such a record can assure or guarantee the security of the user 105 during the user's 105 current trip or future trips.

In some embodiments, the system provides the user the opportunity to send a distress signal via the system through a portable electronic device of the user at any time during transport. In an example, the system provides the user the opportunity to use a panic or emergency button as part of a graphical user interface (GUI) of the user's portable electronic device. An alert can then be sent to law enforcement and/or designated third parties with the users' location and query data. Such law enforcement and/or designated third parties may then respond to assist the user.

In some cases, the system estimates a time of arrival (i.e., estimated time of arrival, or ETA) to a predetermined (or user-defined) destination and request safe arrival confirmation (e.g., with a security code) shortly after arrival. In an example, the ETA is estimated from a route that is optimized in view of traffic conditions that are periodically updated. The system can flag and request users safety confirmation if transportation exceeds the ETA. The system may then send a distress signal to law enforcement agencies and/or designated third parties if safety confirmation is not received from the user with a predetermined time period (e.g., promptly). In an embodiment, the system checks for transport deviations from the charted course via GPS or signal (or wireless) triangulation. If the transport's deviation from the charted course exceeds a set distance, the system would flag and request the user's safety confirmation, sending a distress signal to law enforcement agencies and/or designated third parties, if such confirmation is not received promptly. In some situations, the system calculates the deviation as a linear distance. In an example, if the linear distance between the user's estimated position and expected position is greater than zero (taking into account traffic conditions, in some cases), then the system determines that the user has deviated from the user's charted course and subsequently flags travel and requests the user's safety confirmation. The system in such a case may also send a distress signal to law enforcement agencies and/or designated third parties, such as if the user does not provide safety confirmation.

In some embodiments, the user's safety confirmation is a code or a series of codes that are inputted into a graphical user interface of the user's portable electronic device. The system may require that the code be inputted into the system within a predetermined time limit, such as within 10 seconds. In some cases, the system has an average length of time it takes the user to input one or more codes, and based on the user's current input of codes the system determines whether the user is in distress. In an example, if the user normally inputs a series of three character codes in a time period of 15 seconds (averaged over several trials or upon system setup) and the user inputs the user's series of three character codes in 30 seconds, then the system determines that the user in distress.

In some embodiments, the system may permit the user to input a distress code. The distress code may be recognized by an alleged transport provider or stranger as a non-distress code, but recognized by the system as a distress code. In such a case, the system notifies law enforcement official or a user-selected third party, but does not give any visual or auditory indication to the user that the user is under distress. This may be advantageous in situations in which an alleged transport provider has forcibly instructed (e.g., with the use of a weapon) the user to bypass the abovementioned distress feature of the system.

In an embodiment, the system 100 can allow the user 105 to make database queries via a communication system, including SMS, EMS, MMS, email, telephone or the Internet, and retrieve relevant transportation and police registry information that can be communicated to the user 105 by the same or other communication system, thereby allowing the user 105 to make informed decisions about the safety of boarding a vehicle of the transportation provider 110. The system 100 can also provide a deterrent for criminal activity by creating a record of the user's 105 query, including user account, transport provider license plate(s) and operator(s).

In an embodiment, the system 100 can receive information relating to the transport provider 110 from one or more users. For example, two users can provide information to the system 100 relating to the transport provider 110. Information from multiple users can be provided simultaneously or in succession (i.e., one after another).

Multiple users share a transport (cab, bus, super-shuttle, etc.) or request legitimacy info on a cab. In an embodiment, the system may ask users how many passengers accompany them on the ride for safety purposes. The system may allow for multiple users' mobile devices to communicate in proximity and send a “group” query automatically registering all user identities in the query, and replying to all, as well as storing and forwarding information to law enforcement and/or designated third parties. The system may also recognize through simultaneous queries on a single transport or geographically close queries that users are sharing a transport, individually, or in a group. The system can keep files or other data on strangers sharing a transport with one or more users, such as store a picture of the stranger, together with the users' transport query. The system can also have all users rate the transportation operator, or people they share the transport with.

In embodiments, the system 100 can provide the following functionalities: transport owner recognition; transport operator recognition; transport operator vehicle recognition; transport operator vehicle license plate recognition; operator photo recognition; operator voice recognition; GPS mapping and tracking of user and transport operator vehicle; communication of information regarding one or more users' journeys to preselected locations (including third party locations) and to the authorities in the case of threats or suspected crimes; and maintenance of records of queries and responses. The system 100 can receive information from the user 105 in the form of an image, such as a digital image (still or video), biometric data, a voice exemplar, or text information, such as a description of the transport operator, the transport operator's vehicle, or license plate information. In an embodiment, the system 100 can receive a mobile message (e.g., a Multimedia Message Service message by mobile telephone) from the user 105 having information relevant to the alleged transportation provider 110, such as, e.g., the transportation provider's 110 picture, fingerprints, license plate number (including a picture of the license plate), or other identification number.

In an embodiment, upon a user querying the system as to the legitimacy of a transportation operator, the system can deliver an immediate answer to the user (e.g., via SMS, EMS or MMS) with the most recent relevant police and transportation registry information. Such information can include information about the user's choice of transport and its operator, including, for example, whether the vehicle of the operator has been reported stolen, whether the vehicle is properly registered and insured, the vehicle's affiliation to a call-in or base station, the owner's name, the operator's name and the operator's picture.

In an embodiment, the system 100 can include one or more databases that can maintain a record of the user's 105 query. The record can be for use by the user 105, law enforcement authorities, or designated third parties in the event of a crime or for the retrieval of forgotten or lost items. The record can include all relevant query data, including query timestamp, the location of the user 105, license information of the vehicle operated by the transportation provider, license plate of the vehicle operated by the transportation provider, make and model of the vehicle, identity of the transportation provider 110 (e.g., owner and/or driver) (also “operator” herein), images, video or biometric data, the system's query response, mobile number of user 105, and the email address of the user 105.

The system 100 can be configured to store various types of data relating to the user 105, the operator 110, or both. Such data can include operator characteristic information, user contact information, query timestamp and operator criminal history.

In an embodiment, the system 100 can be configured to accept information relating to the user's 105 confidence in the operator 110. In an embodiment, the user 105 can provide the system 100 information about the user's degree of confidence or trust in the operator 110. For example, if the user 105 has little or no confidence in the legitimacy of the operator 110, the user can provide the system 100 textual information capturing the user's 105 lack of confidence in the operator 110. Such information can be used by the system 100 to warn other user's as to the legitimacy of the operator 110.

In an embodiment, the system 100 can receive and record images sent by users of a selected vehicle's license plate or its operator for optical character recognition (“OCR”) or facial recognition system queries. Such images can be recorded in one or more databases of the system 100. In addition, the system 100 can create a record of one or more users' trips for accountability and security purposes in the event the one or more users board an unregistered vehicle or vehicle for which no information in the database is available.

The system 100 can be configured for various notification functionalities. In some embodiments, the system 100 can be configured for notification to pre-designated third party email addresses and mobile numbers (of friends and family, for example) at the beginning of a user's journey. In some situations, notifications are communicated to a social network or other network communication system, such as, for example, systems selected from instant messaging systems (e.g., America Online, IM), Twitter, Facebook, or Google+, Skype, Microsoft Messenger, Black Berry Messenger, WhatsUp, iMessage, and the like. The system 100 can provide confirmation of the user's 105 safe arrival at a particular destination. In an embodiment, upon the arrival of the user 105 at a particular location, the user 105 can send the system 100 (e.g., via SMS) a secret confirmation code. If the code is correct, a safe journey SMS can be sent; if the code is incorrect, an alert can be sent to designated third parties and relevant authorities.

In an embodiment, the system 100 can be configured to provide transportation service routing. The system 100 can provide nearby transportation options upon request from the user 105, which can enable the user 105 to locate other users and taxis. In an embodiment, users, other users and transportation providers (e.g., taxis, buses) can be located via a GPS mobile locator. In another embodiment, users, other users and transportation providers can be located via signal triangulation, such as WiFi or wireless tower signal triangulation. This can allow the system 100 to assess the legitimacy of a transportation provider 110 by comparing the user's 105 location with the transport provider's 110 location and alerting users 105 to location discrepancies between the two.

In an embodiment, the system 100 can be configured to detect a sudden loss or interruption of transmittal signal from users' 105 portable electronic devices after a query and report such loss or interruption to relevant authorities and/or to users' designated third parties, providing them with query information, the user's 105 and vehicle's last known location, and in some cases the location where signal transmission is resumed.

In an embodiment, the system 100 can provide a crime map to the user 105. The system 100 can create and maintain a crime map, such as a statistical crime map, on user and police reports regarding crimes perpetrated on public and private transportation and upon pedestrians upon boarding and disembarking, as well as of crimes perpetrated on system users. This can enable the user 105 to assess the likelihood of encountering an illegitimate transportation provider (also “operator” herein), as well as to law enforcement agencies to discover crime patterns of transport operators who may be accomplices or accessories to crimes.

In an embodiment, the system can offer transport reservations (bookings), electronic payments and receipts, and expense reporting. This may help users and transport operators carry less cash, making it safer for both by making them a less desirable target. This may allow users and transport operators to pre-screen each other and have a trace of each other's identities. In some situations the system provides crime maps to alert users of dangerous zones. The system may also provide transport operators a tool to track its units and prevent underreporting of services rendered by drivers, as well as unauthorized breaks or journeys. The system may also provide base stations monitoring capabilities with the aid of GPS or signal (or wireless) triangulation. Such monitoring capabilities may be used to monitor the location of transports at all times. Electronic receipts and payments allow for easier, better and safer management and reporting, as well as helping avoid tax evasion by creating a report on operators and users.

In an embodiment, the system can offer advertisements, such as the advertisement of goods and services, to users. The advertisements may be provided on the basis of a route travelled, the user's present location, stated preferences, personal profiles, or other information, such as recommendations of points of interest along the way and at certain destinations.

In an embodiment, the system 100 can offer crime insurance to users 105 at the time of query (e.g., free or paid insurance in case users are subjected to crimes in a transport queried in the system) or after assessing the legitimacy of a transport provider. In an embodiment, the system can offer crime insurance to passengers riding with legitimate transport operators (e.g., temporarily when traveling with precious cargo on a registered transportation provider). In some embodiments, the system provides a user insurance if the system deems that a transport provider or stranger in the transport is illegitimate. In some cases, the system can provide the user insurance if the stranger or transport provider is deemed legitimate. In some situations, a transport is booked through the system or booked by a user upon the system deeming a transport provider legitimate. Insurance companies can reward insurance owners for verifying transport or users legitimacy before using a transport (both for operators and users). In some cases, insurance companies provide lower insurance costs for users of legitimate transport operators with better safety records, as well as for transport operators when booking through a database of registered users in the system, which may prevent robberies on transport operators. In some cases, free, reduced rate, or flat fee insurance may be offered by the system or an insurance company as an incentive for users to use the system.

In an embodiment, the system 100 can provide the user 105 a map showing transportation usage, user concentration and legitimate call locations. The system 100 can create and maintain a traffic map with users' information requests to provide additional services in the future, such as taxi services and insurance (e.g., crime insurance).

In an embodiment, the system 100 can include a transportation service scoring module. The system 100 can allow users to rate the quality of transportation services and share their experience with other users. The system 100, through the module, can provide the user 105 information as to other users' experiences with particular operators.

With continued reference to FIG. 1, the system 100 can include one or more modules configured to retrieve information from the user 105, assess the reliability of the alleged transport provider 110, and provide reliability information 115 to the user 105. In an embodiment, the system 100 can include a first module for receiving information from the user 105, a second module for processing the information, and a third module for providing reliability information 115 to the user 105. Each module can include one or more databases for storing and accessing information. The second module can use the information received from the user 105 to assess the reliability (or legitimacy) of the transport provider 110. In an embodiment, if the alleged transportation provider 110 is illegitimate (e.g., criminal), the second or third module can flag the transport provider 110 as illegitimate. The third module can then transmit to the user 105 an indication (e.g., verbal or visual indication) that the transport provider 110 is illegitimate.

With continued reference to FIG. 1, in an embodiment, the system 100 can include a list of transportation providers. Each entry can include the name and identity of the transportation provider, the last seen location of the transportation provider, and a flag (e.g., Boolean operator) indicating whether the transportation provider is legitimate. The flag can be updated as new information becomes available, such as information from the user 105, other users, and peripheral systems 120. For example, if a formerly illegitimate transportation provider becomes legitimate, the system 100 can update the transportation provider's flag to legitimate.

In an embodiment, the system 100 provides each user 105 a user account that is accessible by each user. In such a case, the user 105 can have a user account associated with the user 105, in addition to other users. The system 100 can store information relating to each user, such as the user's contact information, query timestamp, the operator queried, the identity of the operator queried (e.g., picture), user's 105 and vehicle's GPS location and information provided to the user. In some embodiments, the system may have business accounts, with an account manager who has access to all users query history, and individual accounts for each of the employees.

With continued reference to FIG. 1, the system 100 can accept queries from and provide reliability information to a plurality of users. In an embodiment, the system can store current information and constantly update information with respect to each user. For instance, the system 100 can record and update the times and locations each user accessed the system to query the legitimacy of a particular transportation provider. This can permit the system 100 to generate a reliability map (and statistics) to provide users. In an embodiment the reliability map alerts users to areas with heavy illegitimate transport presence. In another embodiment, the reliability map is a traffic map that allows for pre-certified safe transport routing to heavy demand areas at peak times.

In an embodiment, the system 100 can include a profile for the user 105, as well as other users. The profile of the user 105 can include the preferences of the user 105, which can include transportation operator (also “operator” herein) demographic characteristics, such as gender of the driver, a race of the driver, an age of a driver, an educational level of the driver, a professional status (e.g., education level, occupation type, or the like) of the driver, and the like. In addition, operator characteristics can include any criminal record of the operator, a credit report (or credit history) of the operator, an interest (e.g., science fiction, reality TV, or the like) or hobby of the driver, the political persuasion of the operator, the religion of the operator, operator insurance coverage and limits and operator driving record. User preferences related to an operator's vehicle characteristic can include: vehicle type (e.g., body style, such as sport utility vehicle (SUV) or truck); vehicle emissions levels (e.g., whether the vehicle is a low emissions vehicle; an engine type of the vehicle (e.g., diesel, hybrid, etc.); fuel efficiency rating of the vehicle; vehicle make, model, and/or year; vehicle color; vehicle options (e.g., air conditioning, tinted windows, etc.); the availability of GPS and/or location monitoring systems in the vehicle; and the availability of navigation systems in the vehicle (e.g., GPS and/or OnStar®).

In an embodiment, the system 100 can include a profile of the transportation provider 110 for the user 105. The profile of the transportation provider 110 can include transportation operator (also “operator” herein) demographic characteristics, such as gender of the driver, a race of the driver, an age of a driver, an educational level of the driver, a professional status (e.g., education level, occupation type, or the like) of the driver, and the like. In addition, operator characteristics can include any criminal record of the operator, a credit report (or credit history) of the operator, an interest (e.g., science fiction, reality TV, or the like) or hobby of the driver, the political persuasion of the operator, the religion of the operator, operator insurance coverage and limits and operator driving record. An operator's vehicle characteristic can include: vehicle type (e.g., body style, such as sport utility vehicle (SUV) or truck); vehicle emissions levels (e.g., whether the vehicle is a low emissions vehicle; an engine type of the vehicle (e.g., diesel, hybrid, etc.); fuel efficiency rating of the vehicle; vehicle make, model, and/or year; vehicle color; vehicle options (e.g., air conditioning, tinted windows, etc.); the availability of GPS and/or location monitoring systems in the vehicle; and the availability of navigation systems in the vehicle (e.g., GPS and/or OnStar®).

In some cases, transportation providers (e.g., drivers) can register in the system providing their own information, which can be provided to users subject to verification or with the appropriate caveats. In addition, they can establish driver preferences relating to requesters to control the type of requesters to which the driver is willing to provide transportation services. The driver preferences can relate to user demographic characteristics, such as a passenger age, gender, race, education level and occupation. In addition, user characteristics can relate to: user interests, hobbies, religion, political persuasion, credit rating and criminal record.

With reference to FIG. 1, the memory location 101 may include random-access memory (RAM) and/or read-only memory (ROM). The communications interface 102 may include a network interface for enabling the system 100 to interact with an intranet, including other systems and subsystems, and the Internet, including the World Wide Web. The data storage unit 103 may include one or more hard disks and cache for data transfer and storage. The data storage unit 103 may include one or more databases, such as a relational database. In some cases, the system 100 further includes a data warehouse for storing information, such user, stranger and transport operator information (e.g., profiles, previous activity). In some embodiments, the system 100 may include a relational database and one or more servers, such as, for example, data servers. The system 100 may include one or more communication ports (COM PORTS), one or more input/output (I/O) modules, such as an I/O interface. The processor 104 may be a central processing unit (CPU) or a plurality of CPU's for parallel processing.

The system 100 may be configured for data mining and extract, transform and load (ETL) operations, which may permit the system to load information from a raw data source (or mined data) into a data warehouse. The data warehouse may be configured for use with a business intelligence system (e.g., Microstrategy®, Business Objects®).

Aspects of the systems and methods provided herein may be embodied in programming Various aspects of the technology may be thought of as “products” or “articles of manufacture” typically in the form of executable code and/or associated data that is carried on or embodied in a type of machine readable medium. “Storage” type media may include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server or an intensity transform system. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The system 100 is configured to communicate with one or more remote devices, such as a remote electronic device of the user 105. Such remote connection is facilitated using the communications interface 102. In some situations, the system 100 presents information to the user 105 by way of a user interface on an electronic device of the user 105. The user interface can be a graphical user interface (GUI). In some case, the GUI operates on an electronic device of the user 105, such as a portable electronic device (e.g., mobile phone, Smart phone). The electronic device can include an operating system for executing various software and the graphical user interface of the electronic device.

In some embodiments, the system 100 provides alerts, updates, notifications, warnings (e.g., “DO NOT ENTER THE CAB”), and/or other communications to the user by way of a graphical user interface operating on an electronic device of the user. The GUI may permit the user to access the system to, for example, create or update a profile of the user, or to review a profile of an alleged stranger (see below) or an alleged transport operator.

### Methods for Providing Transportation Provider Reliability Information

In another aspect of the invention, methods are provided for providing a user transportation provider reliability information. Methods provided herein can permit a user to assess the reliability (including legitimacy) of a transportation provider.

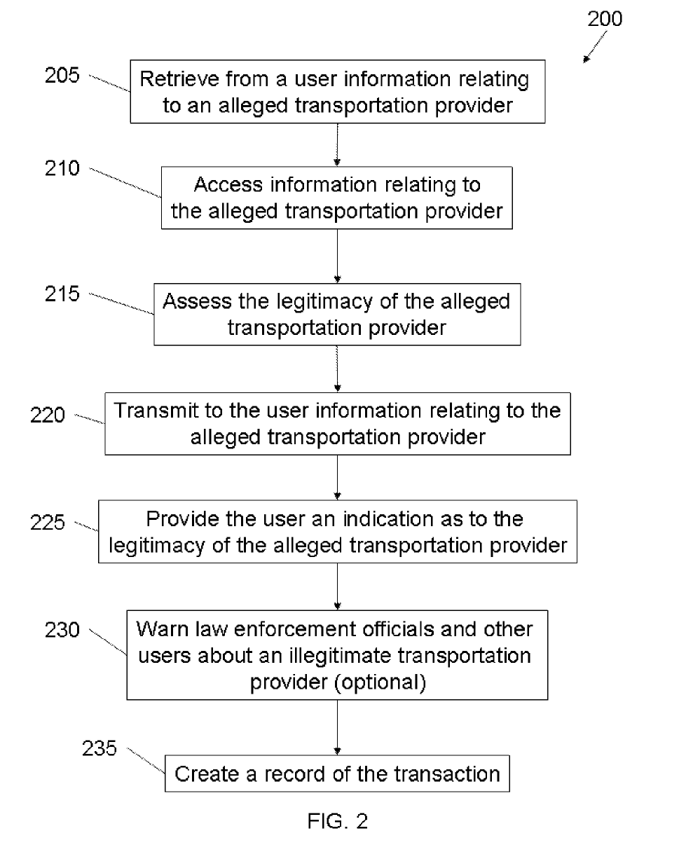

With reference to FIG. 2, a method 200 for assessing the legitimacy of a transportation provider (or operator) is illustrated, in accordance with an embodiment of the invention. In a first step 205, the system retrieves from a user information relating to an individual or entity alleging to be a transportation provider (the “alleged transportation provider”). In an embodiment, the user transmits to the system information about the alleged transportation provider, which can come by way of a system query.

With continued reference to FIG. 2, in a second step 210, the system accesses information relating to the alleged transportation provider. The system can retrieve information from various sources, such as one or more of the system's database(s) and peripheral systems, including crime databases.

Next, in a third step 215, the system can assess whether the alleged transportation provider is a legitimate transportation provider (i.e., not fraudulent or criminal) In an embodiment, the system compares the information provided by the user to information gathered by the system, other systems (including databases) and other users. In an embodiment, the system can compare the information provided by the user against criteria contained in the user's preferences, which can be included in the user's system profile (see above). In an embodiment, if there is any criminal activity associated with the alleged transportation provider, the system can designate the alleged transportation provider as illegitimate. In an embodiment, the system can flag the alleged transport provider as legitimate (e.g., if not criminal) or illegitimate (e.g., if criminal). In an embodiment, assessing whether the alleged transportation provider is a legitimate transportation provider can include the system determining one or more of whether the alleged transportation provider has a criminal record, whether the alleged transportation provider is driving a stolen, unregistered or disguised vehicle, and whether the alleged transportation provider is a criminal.

Next, in a fourth step 220, the system transmit to the user information relating (or relevant) to the alleged transportation provider. Such information can relate to the legitimacy of the alleged transportation provider.

With continued reference to FIG. 2, in a fifth step 225, the system can provide the user an indication as to the legitimacy of the alleged transportation provider. In an embodiment, the system can provide the user a verbal or visual indication as to whether the alleged transportation provider is legitimate. For example, if the alleged transportation provider is a criminal, the system can provide the user a warning signal (e.g., “DO NOT ENTER THE TAXICAB”). In a sixth step 230, if the alleged transportation provider is illegitimate (e.g., criminal), the system can warn law enforcement officials and other users. In an embodiment, upon other users querying the system about the legitimacy of the transportation provider, the system can warn those users that the transportation provider is illegitimate. In a seventh step 235, the system can create a record of the transaction by the user (i.e., the user's query, information gathered by the system, and information provided to the user). The record can include information about the user, the transportation provider, or both.

In one embodiment, the system can provide crime insurance and other services to users based on the assessment of the legitimacy of the transport of choice (or transportation provider) and preferences provided by users.

In an embodiment, the system can update peripheral systems with information retrieved from the user. For example, the system can update one or more of citizen, police and government databases with information about the identity of the alleged transportation provider and the vehicle (including license plate) operated by the alleged transportation provider.

In embodiments, the system retrieves information from the user when the user queries the system. For instance, the user can query the system if the user wants to assess the legitimacy of an alleged transportation provider. In an embodiment, the user can query the system (e.g., via SMS, EMS, MMS, email, telephone, applications for portable electronic devices (e.g., smart phones, tablets) or the Internet) with a license plate number, operator name, transport image, license plate picture, operator picture or operator voice sample to the database, which will return available information on the associated mode of transportation, including the operator's (or driver's) name and profile. In some situations, the user queries the system through a social network or other network communication system, such as, for example, systems selected from instant messaging systems (e.g., America Online, IM), Twitter, Facebook, or Google+, Skype, Microsoft Messenger, Black Berry Messenger, WhatsUp, iMessage, and the like.

In some embodiments, a computer-implemented method for assessing the legitimacy of a stranger comprises a server (e.g., the system 100 of FIG. 1) retrieving from a user information relating to an alleged stranger in a transport vehicle occupied by the user and the alleged stranger. The transport vehicle can be occupied by the user and the alleged stranger concurrently. In some cases, the alleged stranger is an alleged transport operator. Next, from a memory location, the server accesses any information relating to the alleged stranger. Next, with the aid of a processor operatively coupled to the memory location, the system determines a likelihood that the alleged stranger will commit a crime against the user. Such determination can be made using rules provided by the user or a third party (e.g., law enforcement agency). In an example, the determination is made on the basis of whether the stranger has exhibited criminal activity and the transport vehicle has deviated from a charted route. In such a case, if the stranger has had previous criminal activity and the transport vehicle has deviated from a system-calculated route, then the system determines that the stranger has an appreciable likelihood (e.g., more likely than not) of committing a crime against the user. Based on the processor-determined likelihood, the system alerts one or more of the user, a law enforcement official and user-selected third parties.

In some cases, the system provides the user crime insurance and other services based on the processor-determined likelihood and/or preferences provided by the user.

In some situations, determining the likelihood that the alleged stranger will commit a crime against the user comprises determining one or more of whether the alleged stranger has a criminal record, whether the alleged stranger is driving a stolen, unregistered or disguised vehicle, and whether the alleged stranger is a criminal or has exhibited criminal behavior. In some cases, the system has a rules file or table with rules that aid in determining whether the stranger has an appreciable likelihood of committing a crime against the stranger.

In some situations, the system determines, with the aid of a processor, the likelihood that the alleged stranger will commit a crime against the user within a time period in which the user and the alleged stranger concurrently occupy said transport vehicle. In an example, the system determines whether it is more likely than not that the alleged stranger will commit a crime against the user while the user and the alleged are sharing a taxi cab.

In some embodiments, the system determines the legitimacy or illegitimacy of a stranger or transport provider before the user boards a transport. Such determination can be made with the aid of, e.g., the history of the stranger or transport provider.

### EXAMPLE

A user enters a cab and instructs the cab driver to take the user to a user-selected location (e.g., a shopping center). The user has a portable electronic device that is in communication with a transportation provider reliability assessment system, such as the system 100. The portable electronic device has a graphical user interface (GUI) and a global positioning system (GPS). The cab driver drives to an alleyway. Upon the threat of force to the user, the cab driver instructs the user to input a code into a GUI of the user's portable electronic device to prevent the system from determining that the user is under distress (such as, for example, if the system finds that the alleyway was not on the user's charted route and would thus find that the user is under distress). The user inputs a code that the system recognizes as a distress code, but that the cab driver believes is the user's ordinary code and thus intended to notify the system that the user is not under distress. The system finds that the user is under distress and instructs the local police to assist the user at the location of the user (e.g., identified by a GPS of the user's portable electronic device).

It shall be understood that concepts of the invention can be incorporated with other methods and systems to provide more secure for-hire transportation. Methods and systems provided herein can be combined with and/or modified by various methods or systems, including components, subsystems or subparts of any such methods or systems. For example, methods and systems provided herein can be combined and/or modified with one or more of U.S. Pat. No. 4,360,875 to Behnke (“AUTOMATED, DOOR-TO-DOOR, DEMAND-RESPONSIVE PUBLIC TRANSPORTATION SYSTEM”), U.S. Patent Publication No. 2006/0276960 to Adamczyk et al. (“METHODS, SYSTEMS AND COMPUTER PROGRAM PRODUCTS FOR RIDE MATCHING BASED ON SELECTION CRITERIA AND DRIVER CHARACTERISTIC INFORMATION”), U.S. Patent Publication No. 2009/0216600 to Hill (“SYSTEMS AND METHODS FOR ARRANGING A TRANSPORT TRANSACTION”), U.S. Patent Publication No. 2010/0153279 to Zahn (“SYSTEMS AND METHODS FOR GLOBAL TRANSPORTATION, VETTING, AND PAYMENT”), U.S. Patent Publication No. 20080189148 to Diaz et al. (“GROUND TRANSPORTATION BOOKING”) and WO/2006/069445 to Trest (“DYNAMIC INFORMATION SYSTEM”), which are entirely incorporated herein by reference.

While preferable embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A system for assessing the legitimacy of a transportation provider, comprising:
a first module configured to receive information relating to an alleged transportation provider from a user and store said information in a memory location;
a second module operatively coupled to the first module, the second module for using the information received from the user to assess, with the aid of a processor, the legitimacy of the alleged transportation provider; and
a third module operatively coupled to the second module, the third module for transmitting to the user an indication as to the legitimacy of the alleged transportation provider.

2. The system of claim 1, further comprising a module configured to offer crime insurance and other services to users.

3. (canceled)

4. A computer-implemented method for assessing the legitimacy of an alleged-stranger, comprising:
(a) retrieving from a user information relating to an alleged stranger, wherein said user is occupying a transport vehicle with said alleged stranger or about to occupy the transport vehicle with said alleged stranger;
(b) accessing, from a memory location, information relating to the alleged stranger;
(c) determining, with the aid of a processor operatively coupled to said memory location, a likelihood that the alleged stranger will commit a crime against the user; and
(d) based on the processor-determined likelihood, alerting one or more of the user, a law enforcement official and user-selected third parties.

5. The computer-implemented method of claim 4, further comprising providing crime insurance and other services to the user based on the processor-determined likelihood and/or preferences provided by the user.

6. The computer-implemented method of claim 4, wherein determining the likelihood that the alleged stranger will commit a crime against the user comprises determining one or more of whether the alleged stranger has a criminal record, whether the alleged stranger is driving a stolen, unregistered or disguised vehicle, and whether the alleged stranger is a criminal or has exhibited criminal behavior.

7. The computer-implemented method of claim 4, wherein said alleged stranger is an alleged transport operator.

8. The computer-implemented method of claim 4, wherein step (c) comprises determining, with the aid of said processor, the likelihood that the alleged stranger will commit a crime against the user within a time period in which the user and the alleged stranger concurrently occupy said transport vehicle.

9. (canceled)

10. A computer-implemented method for assessing the legitimacy of a transportation provider, comprising:
(a) retrieving from a user information relating to an alleged transportation provider;
(b) accessing, from a memory location, information relating to the alleged transportation provider;
(c) assessing, with the aid of a processor operatively coupled to said memory location, whether the alleged transportation provider is a legitimate transportation provider;
(d) flagging the alleged transportation provider as legitimate or illegitimate based on said assessment; and
(e) transmitting to the user information relating to the legitimacy of the alleged transportation provider.

11. The computer-implemented method of claim 10, wherein assessing whether the alleged transportation provider is a legitimate transportation provider comprises determining whether the alleged transportation provider has deviated from a predetermined route.

12. The computer-implemented method of claim 10, wherein assessing whether the alleged transportation provider is a legitimate transportation provider comprises determining whether the user has inputted a user-specific code into an electronic device of said user.

13. The computer-implemented method of claim 10, further comprising notifying a law enforcement official or a user-designated third party after said flagging.

14. The computer-implemented method of claim 10, further comprising updating said information relating to the alleged transportation provider.

15. The computer-implemented method of claim 10, further comprising providing crime insurance and other services to the user based on the assessment of the legitimacy of the transportation provider and/or preferences provided by the user.

16. The computer-implemented method of claim 10, wherein assessing whether the alleged transportation provider is a legitimate transportation provider comprises determining one or more of whether the alleged transportation provider has a criminal record, whether the alleged transportation provider is driving a stolen, unregistered or disguised vehicle, and whether the alleged transportation provider is a criminal or has exhibited criminal behavior.

17.-19. (canceled)

20. The system of claim 1, further comprising a graphical user interface (GUI) for providing the user the indication as to the legitimacy of said alleged transportation provider.

21. The system of claim 20, wherein said GUI is on an electronic device of said user.

22. The system of claim 20, wherein said notification is a visual notification.
